(19) United States
(12) Patent Application Publication
(10) Pub. No.: US 2025/0141806 A1
(43) Pub. Date: May 1, 2025

(54) METHOD FOR PROVIDING TSN TRANSPORT FUNCTIONALITY IN MOBILE COMMUNICATION SYSTEM AND APPARATUS THEREOF

(71) Applicant: Electronics and Telecommunications research Institute, Daejeon (KR)

(72) Inventors: Kyung Soo KIM, Daejeon (KR); Changki Kim, Daejeon (KR)

(21) Appl. No.: 18/807,188

(22) Filed: Aug. 16, 2024

(30) Foreign Application Priority Data
Oct. 30, 2023 (KR) 10-2023-0147110
Jul. 31, 2024 (KR) 10-2024-0101688

(51) Int. Cl. H04L 47/2416; H04L 47/28; H04W 48/18

(52) U.S. Cl. CPC H04L 47/2416; H04L 47/28; H04W 48/18

(57) ABSTRACT

Various embodiments for techniques for providing a Time Sensitive Network (TSN) transmission function in a mobile communication system are disclosed. In one embodiment, a method of operating an electronic device performing AMF in a mobile communication system may comprise obtaining information about the TSN talker and listener capabilities of a RAN in the mobile communication system; and transmitting the obtained information to an electronic device performing CUC co-located with SMF.

### CROSS REFERENCE TO RELATED APPLICATIONS

The present application claims priority to Korean Patent Application No. 10-2023-0147110, filed on Oct. 30, 2023 and Korean Patent Application No. 10-2024-0101688, filed on Jul. 31, 2024, the entire contents of which are incorporated herein for all purposes by this reference.

### BACKGROUND

### Technical Field

The present disclosure relates to a technology for providing a Time Sensitive Network (TSN) transmission function in a mobile communication system. More specifically, some embodiments relate to a technology for providing the core network with information regarding the presence or absence of TSN talker/listener capabilities in a Radio Access Network (RAN).

### Description of the Related Art

As the demand for high reliability and low latency services in 5G systems increases, 5G systems are being integrated with Time Sensitive Networking (TSN) systems. By operating as a bridge in a TSN network, 5G systems can handle TSN streams.

### SUMMARY

A technology is provided for offering Time Sensitive Network (TSN) transmission functionality in a mobile communication system (for example, a technology for providing information about the presence or absence of TSN Talker/Listener capabilities in a radio access network (RAN) to a core network).

One aspect of this disclosure provides a method of operating an electronic device performing access and mobility management function (AMF) in a mobile communication system. The method may comprise obtaining information about the time sensitive network (TSN) talker and listener capabilities of a radio access network (RAN) in the mobile communication system; and
transmitting the obtained information to a second electronic device. In some embodiments, the second electronic device may be an electronic device performing a centralized user configuration (CUC) co-located with a session management function (SMF).

In some embodiments, the information about the capabilities may include information on whether the RAN can perform function of TSN Talker and Listener.

In some embodiments, the obtaining step may comprise receiving the information about the capabilities from the RAN.

In some embodiments, the receiving step may comprise receiving the information through next generation application protocol (NGAP) with the RAN.

In some embodiments, the receiving the information through the NGAP may comprise receiving an NG setup request message including the information from the RAN.

In some embodiments, the receiving the information through the NGAP may comprise receiving a RAN configuration update message including the information from the RAN.

In some embodiments, the receiving step may comprise receiving the information from a base station of the RAN.

Another aspect of this disclosure provides a method of operating an electronic device performing a CUC co-located with a SMF in a mobile communication system. The method may comprise receiving information about the TSN Talker and Listener capabilities of a RAN in the mobile communication system from a second electronic device; and configuring a time-sensitive transport network by interworking with a third electronic device based on the received information. In some embodiments, the second electronic device may be an electronic device performing an AMF, and the third electronic device may be an electronic device performing a centralized network configuration (CNC) deployed in a transport network.

In some embodiments, the configuring the time-sensitive transport network may comprise communicating with a fourth electronic device and a fifth electronic device by interworking with the third electronic device to configure the time-sensitive transport network. In some embodiments, the fourth electronic device may be an electronic device performing access network talker and listener (AN-TL) function, and the fifth electronic device may be an electronic device performing core network talker and listener (CN-TL) function.

In some embodiments, the configuring the time-sensitive transport network may comprise the electronic device performing the CUC providing the third electronic device with stream requirements in the transport network based on QOS flow-based stream requirements, and the third electronic device configuring paths and schedules for the time-sensitive transport network based on the provided stream requirements.

In some embodiments, the second electronic device may receive the information from the RAN and provide the received information to the electronic device performing the CUC.

In some embodiments, the second electronic device may receive the information through NGAP.

Another aspect of this disclosure provides an electronic device that can be included in a mobile communication system comprising: A processor; one or more hardware-based transceivers; and a computer-readable storage medium containing instructions, which, in response to execution by the processor, cause the base station to perform at least one embodiment of the method of this disclosure.

Another aspect of this disclosure provides a non-transitory recording medium storing instructions readable by a processor of an electronic device, wherein the instructions cause the processor to perform embodiments of this disclosure.

This summary is provided to introduce a selection of concepts in a simplified form that are further described in the detailed description below. This summary is not intended to identify key or essential features of the claimed subject matter, nor is it intended to be used to limit the scope of the claimed subject matter. The claimed subject matter is not limited to implementations that solve any or all disadvantages noted in any part of this disclosure. In addition to the exemplary aspects, embodiments, and features described above, further aspects, embodiments, and features will become apparent from the following detailed description and accompanying drawings.

Some embodiments of this disclosure may have an effect including the following advantages. However, since it is not meant that all exemplary embodiments should include all of them, the scope of the present disclosure should not be understood as being limited thereto.

According to some embodiments, in a mobile communication network supporting TSN TN, by conveying the AN-TL support capability of the RAN to the AMF, the AMF can convey the AN-TL support capability of the RAN to the SMF/CUC, thereby enabling the SMF/CUC to communicate with the AN-TL and CN-TL to configure a TSN-supported transport network.

### BRIEF DESCRIPTION OF THE DRAWINGS

FIG. 1 illustrates the 5GS network architecture proposed in 3GPP Rel-16, exemplifying a network structure where 5GS operates as a single logical TSN bridge when integrated with TSN.

FIG. 2 illustrates another example of a 5G network architecture where a TSN transport network is configured in the transport network between the RAN and UPF, which is the N3 reference point in FIG. 1.

FIG. 3 is a diagram illustrating a method for transmitting information regarding the AN-TL support capability of the RAN, according to some embodiments.

FIG. 4 is a diagram illustrating a method for transmitting information regarding the AN-TL support capability of the RAN, according to other embodiments.

FIG. 5 is a block diagram illustrating an internal configuration of an electronic device (e.g., communication device, network device) according to an embodiment of the present disclosure.

### DETAILED DESCRIPTION OF THE DISCLOSURE

Since the description of the present disclosure is merely an exemplary embodiment for structural or functional description, the scope of the present disclosure should not be construed as being limited by the exemplary embodiments described in the text. That is, since exemplary embodiments may be changed in various ways and may have various forms, it should be understood that the right scope of the present disclosure includes equivalents that can realize the technical idea. In addition, the objectives or effects presented in the present disclosure may not mean that a specific exemplary embodiment should include all or only such effects, so the right scope of the present disclosure should not be understood as being limited thereto.

Meanwhile, the meaning of the terms described in the present disclosure should be understood as follows.

Terms such as “first”, “second”, and the like are intended to distinguish one component from another component, and the scope of rights should not be limited by these terms. For example, a first component may be referred to as a second component, and similarly, a second component may also be referred to as a first component.

When a component is referred to as being “connected” to another component, it may be directly connected to the other component, but it should be understood that other components may exist in the middle. On the other hand, when a component is referred to as being “directly connected” to another component, it should be understood that no other component exists in the middle. Meanwhile, other expressions describing the relationship between components, such as “between” and “immediately between” or “neighboring to” and “directly neighboring to”, should be interpreted in the same way.

Singular expressions should be understood to include plural expressions unless the context clearly indicates otherwise, and terms such as “include” or “have” are intended to designate the existence of features, numbers, steps, actions, components, parts, or combinations thereof, and should be understood not to preclude the possibilities of the existence or addition of one or more other features or numbers, steps, actions, components, parts, or combinations thereof.

In each step, identification codes (e.g., a, b, c, etc.) may be used for the convenience of explanation, and identification codes may not describe the order of each step, and each step may occur differently from the specified order unless a specific order is explicitly stated in the context. That is, each step may occur in the same order as the specified order, may be performed substantially simultaneously, or may be performed in the opposite order.

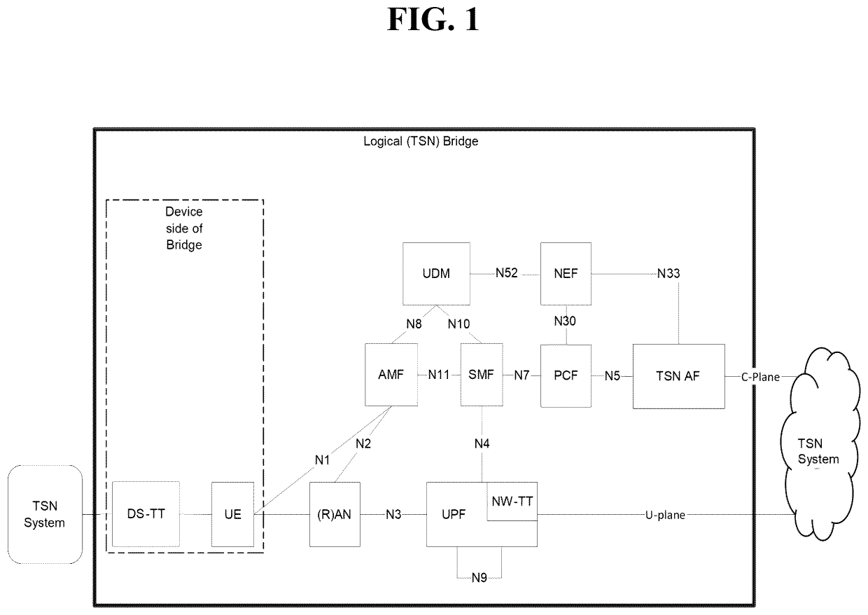

FIG. 1 illustrates the 5GS network architecture proposed in 3GPP Rel-16, exemplifying a network structure where 5GS operates as a single logical TSN bridge when integrated with TSN.

Through this integration, the 5GS can interact with TSN in the same manner as a TSN bridge (or switch), enabling the proper transmission and processing of TSN streams. For detailed information on each logical function node, refer to the TS23.501 specification.

Meanwhile, to completely and correctly handle end-to-end TSN traffic in FIG. 1, it is understood that the transport network (N3 segment) between the RAN and the UPF (User Plane Function) within the logical TSN bridge must also support TSN processing functions. To this end, 3GPP is standardizing TSN TN (TSN-enabled Transport Network) in Rel 18 (5G-Advanced System).

To support interworking with TSN deployed in the transport network, the CUC (Centralized User Configuration), co-located with the SMF (Session Management Function), may interact with the CNC (Centralized Network Configuration) deployed in the transport network. The SMF/CUC may then communicate with the AN-TL deployed in the RAN and the CN-TL deployed in the UPF to configure a TSN-supported transport network. In this scenario, the RAN and UPF serve as end stations for the TSN TN. Specifically, in the structure supporting TSN TN, the RAN and UPF function as TSN Talker/Listener, respectively named AN-TL and CN-TL. Therefore, the SMF/CUC must be aware of the TSN Talker/Listener capabilities of the RAN and UPF to support time-sensitive communication using TSN transport.

While methods for the SMF/CUC to determine the TSN Talker/Listener capabilities of the UPF have been studied, methods for conveying the TSN Talker/Listener capabilities of the RAN have not been fully explored. Therefore, a method for this is required.

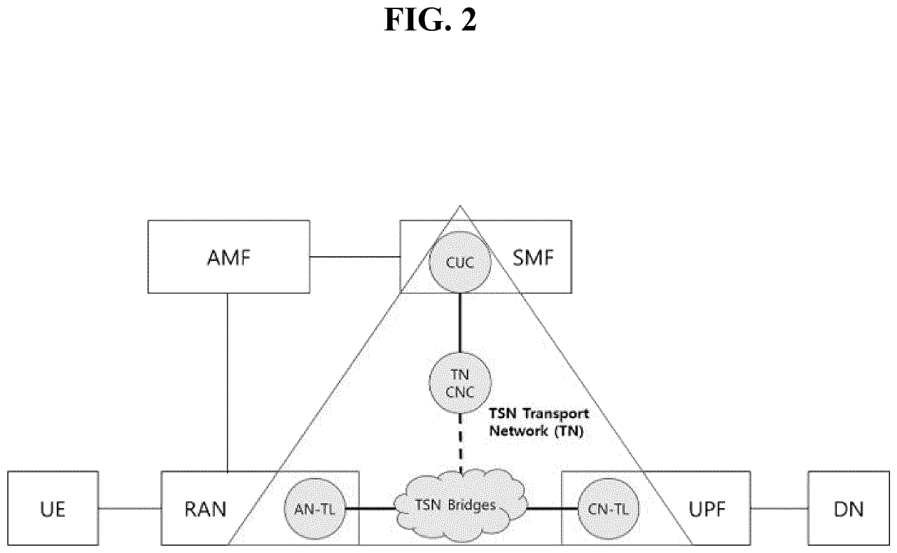

FIG. 2 illustrates another example of a 5G network architecture where a TSN transport network is configured in the transport network between the RAN and UPF, which is the N3 reference point in FIG. 1.

In some embodiments, the functional elements illustrated in FIG. 2 may be mapped similarly to the functional elements that operate as a logical TSN bridge as illustrated in FIG. 1.

In some embodiments, when 5GS supports interworking with IEEE TSN deployed in the transport network, the CUC co-located with the SMF may interact with the TN CNC in the transport network.

In some embodiments, the SMF/CUC may provide the TN CNC with stream requirements in the transport network based on QOS flow-based stream requirements, and the TN CNC may use the stream requirements as input to configure each path and schedule in the transport network.

Meanwhile, when the SMF sets up a new QoS flow, it may signal the RAN with CN PDB (Core Network Packet Delay Budget) and TSCAI (TSC Assistance Information) for the QOS flow on a per-flow basis.

In some embodiments, if the RAN receives TSCAI from the SMF that includes UL BAT (Burst Arrival Time), it may calculate the AN PDB (Access Network Packet Delay Budget) and provide it to the SMF.

In some embodiments, if the RAN and UPF support the TSN Talker/Listener functions, AN-TL and CN-TL, respectively, the SMF/CUC may communicate with the AN-TL and CN-TL through TL-Containers. For example, the SMF/CUC may make requests using get-request and set-request, and the AN-TL and CN-TL may respond with get-response and set-response messages, thereby collecting and conveying capability information of the AN-TL and CN-TL and providing gate control information for TSN communication. Accordingly, the AN-TL and CN-TL enable time-sensitive communication by providing hold and buffer functions.

On the other hand, in conventional methods, there has been no research on a method for the RAN to convey AN-TL support information to the AMF, and thus, there has been no proposed method for the AMF to know the AN-TL support capability from the RAN.

In some embodiments, a method of operating an electronic device (hereinafter, AMF device) performing an AMF in a mobile communication system may comprise obtaining information about the TSN talker and listener capabilities of a RAN in the mobile communication system; and transmitting the obtained information to a second electronic device. For example, the second electronic device may be an electronic device (hereinafter, SMF/CUC device) performing a CUC co-located with a SMF. For example, the mobile communication system may be 5GS.

In some embodiments, the information about the capabilities may include information on whether the RAN can perform function of TSN Talker and Listener.

In some e embodiments, the AMF device may receive the information about the capabilities from the RAN. For example, the AMF device may receive the information from a base station of the RAN.

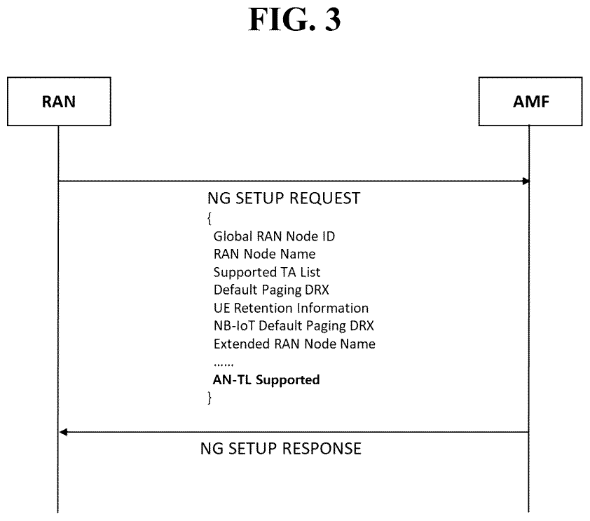

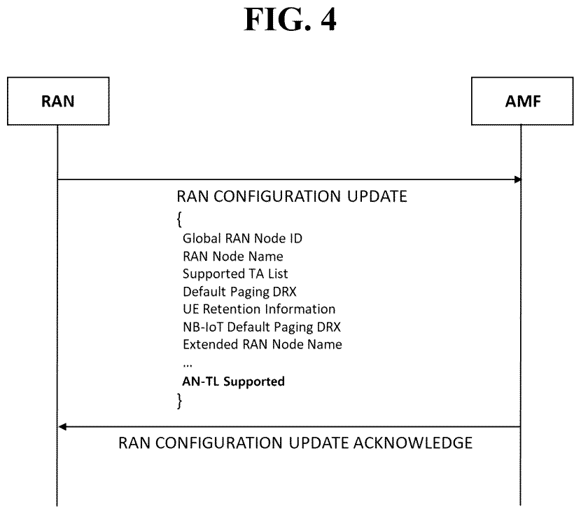

In some embodiments, the AMF device may receive the information through NGAP with the RAN. For example, as described later in FIG. 3, the AMF device may obtain the information by receiving an NG setup request message including the information from the RAN. In another example, as described later in FIG. 4, the AMF device may obtain the information by receiving a RAN configuration update message including the information from the RAN.

In some embodiments, a method of operating an SMF/CUC device may comprise receiving information about the TSN Talker and Listener capabilities of a RAN in the mobile communication system from a second electronic device; and configuring a time-sensitive transport network by interworking with a third electronic device based on the received information. For example, the second electronic device may be an AMF device, and the third electronic device may be an electronic device (hereinafter, CNC device) performing CNC deployed in a transport network.

In some embodiments, the SMF/CUC device may communicate with a fourth electronic device and a fifth electronic device by interworking with the CNC device to configure the time-sensitive transport network. For example, the fourth electronic device may be an electronic device performing access network talker and listener (AN-TL) function, and the fifth electronic device may be an electronic device performing core network talker and listener (CN-TL) function.

In some embodiments, the SMF/CUC device may provide the CNC device with stream requirements in the transport network based on QoS flow-based stream requirements, and the CNC may configure paths and schedules for the time-sensitive transport network based on the provided stream requirements.

In some embodiments, the AMF device may receive the information from the RAN and provide it to the SMF/CUC.

Meanwhile, the method by which the AMF device receives the information from the RAN is the same as described above (e.g., receiving the information through NGAP).

FIG. 3 is a diagram illustrating a method for transmitting information regarding the AN-TL support capability of the RAN, according to some embodiments.

In some embodiments, the RAN may provide the AMF with relevant support information through an NG SETUP REQUEST message including an AN-TL support capability parameter in the NGAP used at the N2 interface between the RAN and AMF.

The NG SETUP procedure exchanges application-level data necessary for proper interworking between the RAN node and the AMF. This procedure is the first NGAP procedure triggered after the TNL (Transport Network Layer) connection is established, where the RAN node transmits to the AMF data necessary for interworking, such as the RAN Node ID, Name, and TA (Track Area) list support.

In some embodiments, as illustrated in FIG. 3, the RAN can additionally transmit to the AMF the AN-TL support capability as a parameter.

In some embodiments, when the AMF receives an NG SETUP request message including the AN-TL support capability from the RAN, it may forward (e.g., the AN-TL support capability) to the SMF/CUC to enable the configuration of a TSN transport network.

FIG. 4 is a diagram illustrating a method for transmitting information regarding the AN-TL support capability of the RAN, according to other embodiments.

In some embodiments, the RAN may provide the AMF with relevant support information through a RAN CONFIGURATION UPDATE message including an AN-TL support capability parameter in the NGAP used at the N2 interface between the RAN and AMF.

The RAN CONFIGURATION UPDATE procedure is used to update application-level data necessary for proper interworking between the RAN node and the AMF at the interface.

In some embodiments, when the AMF receives a RAN configuration including the AN-TL support capability from the RAN, it may forward the corresponding information (e.g., the AN-TL support capability) to the SMF/CUC to enable the configuration of a TSN transport network.

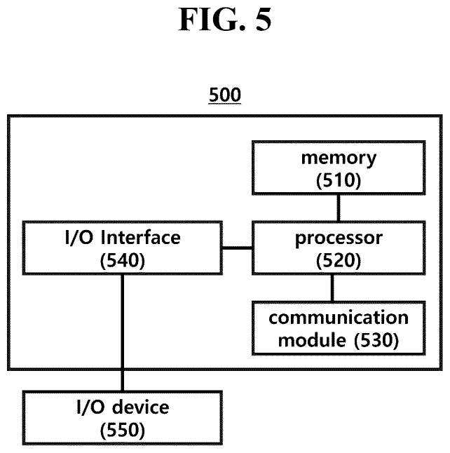

FIG. 5 is a block diagram illustrating an internal configuration of an electronic device (e.g., a communication device, a network device) according to an embodiment of the present disclosure. As shown in FIG. 5, the electronic device (500) may include a memory (510), a processor (520), a communication module (530), and an input/output interface (540).

The memory (510) may be a computer-readable recording medium and may include a RAM (random access memory), a ROM (read only memory), and a non-volatile mass storage device such as a disk drive. Here, the ROM and the non-volatile mass storage devices may be included as separate permanent storage devices apart from the memory (510). Additionally, the memory (510) may store an operating system and at least one program code (e.g., a computer program stored on the recording medium included in the electronic device (500) to control the electronic device (500) to perform methods according to embodiments of the present disclosure). These software components may be loaded from a computer-readable recording medium separate from the memory (510). This separate computer-readable recording medium may include floppy drives, disks, tapes, DVD/CD-ROM drives, memory cards, and other computer-readable recording media. In other embodiments, the software components may be loaded into the memory (510) via the communication module (530) instead of a computer-readable recording medium.

The processor (520) may be configured to process instructions of a computer program by performing basic arithmetic, logic, and input/output operations. The instructions may be provided to the processor (520) by the memory (510) or the communication module (530). For example, the processor (520) may be configured to execute the instructions received according to the program code loaded into the memory (510). As a more specific example, the processor (520) can sequentially execute instructions according to the code of a computer program loaded in the memory (510) to perform beam configuration and/or RIS control according to the embodiments of the present disclosure.

The communication module (530) may provide functions for communicating with other physical devices over an actual computer network. For example, while the processor (520) of the electronic device (500) performs part of the process of the present embodiment, another physical device in the network (e.g., another computing system not shown) can perform the remaining process, and the processing results may be exchanged via the computer network and the communication module (530) to perform the embodiments of the present disclosure.

The input/output interface (540) may serve as a means for interfacing with input/output devices (550). For example, input devices in the input/output devices (550) may include devices such as a keyboard or a mouse, and output devices may include devices such as a display or speakers. In FIG. 15, the input/output devices (550) are represented as separate devices from the electronic device (500), but in some embodiments, the electronic device (500) may be implemented to include the input/output devices (550).

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

What is claimed is:

1. A method of operating an electronic device performing access and mobility management function (AMF) in a mobile communication system, the method comprising:
obtaining information about the time sensitive network (TSN) talker and listener capabilities of a radio access network (RAN) in the mobile communication system; and
transmitting the obtained information to a second electronic device,
wherein the second electronic device is an electronic device performing centralized user configuration (CUC) co-located with session management function (SMF).

2. The method of claim 1, wherein the information about the capabilities includes information on whether the RAN can perform function of TSN Talker and Listener.

3. The method of claim 1, wherein the obtaining step comprises receiving the information about the capabilities from the RAN.

4. The method of claim 3, wherein the receiving step comprises receiving the information through next generation application protocol (NGAP) with the RAN.

5. The method of claim 4, wherein the receiving the information through the NGAP comprises receiving an NG setup request message including the information from the RAN.

6. The method of claim 4, wherein the receiving the information through the NGAP comprises receiving a RAN configuration update message including the information from the RAN.

7. The method of claim 3, wherein the receiving step comprises receiving the information from a base station of the RAN.

8. A method of operating an electronic device performing centralized user configuration (CUC) co-located with session management function (SMF) in a mobile communication system, the method comprising:
receiving information about the time sensitive network (TSN) Talker and Listener capabilities of a radio access network (RAN) in the mobile communication system from a second electronic device; and
configuring a time-sensitive transport network by interworking with a third electronic device based on the received information,
wherein the second electronic device is an electronic device performing access and mobility management function (AMF), and the third electronic device is an electronic device performing centralized network configuration (CNC) deployed in a transport network.

9. The method of claim 8, wherein the configuring the time-sensitive transport network comprises communicating with a fourth electronic device and a fifth electronic device by interworking with the third electronic device to configure the time-sensitive transport network,
wherein the fourth electronic device is an electronic device performing access network talker and listener (AN-TL) function, and the fifth electronic device is an electronic device performing core network talker and listener (CN-TL) function.

10. The method of claim 8, wherein the configuring the time-sensitive transport network comprises the electronic device performing the CUC providing the third electronic device with stream requirements in the transport network based on QOS flow-based stream requirements, and the third electronic device configuring paths and schedules for the time-sensitive transport network based on the provided stream requirements.

11. The method of claim 10, wherein the second electronic device receives the information from the RAN and provides the received information to the electronic device performing the CUC.

12. The method of claim 11, wherein the second electronic device receives the information through next generation application protocol (NGAP).

13. An electronic device for performing access and mobility management function (AMF) in a mobile communication system, the device comprising:
a processor;
one or more hardware-based transceivers; and
a computer-readable storage medium storing instructions,
wherein the instructions, when executed by the processor, cause the device to perform the method of claim 1.
